(19) United States
(12) Patent Application Publication
(10) Pub. No.: US 2003/0061759 A1
(43) Pub. Date: Apr. 3, 2003

(54) Method for expelling harmful insects by volatilization of a chemical

(75) Inventors: Shingi Nishino, Hiroshima (JP); Satoshi Yamasaki, Hiroshima (JP); Masaaki Sugiura, Hiroshima (JP); Atsuhiko Hattori, Hiroshima (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: FUMAKILLA LIMITED, Tokyo (JP)

(21) Appl. No.: 10/200,832

(22) Filed: Jul. 23, 2002

Related U.S. Application Data
(63) Continuation-in-part of application No. PCT/JP01/00611, filed on Jan. 30, 2001.

(30) Foreign Application Priority Data
Apr. 13, 2000 (JP) P2000-111596

(51) Int. Cl. A01M 19/00

(52) U.S. Cl. 43/129

(57) ABSTRACT

A method for excluding or expelling harmful or noxious insects using a preparation containing a chemical which is a non-organophosphorus chemical and which has a higher vapor pressure than d,d-T80-prallethrin and a higher debugging potency than transfluthrin.

### CROSS REFERENCE TO RELATED APPLICATION

This application is a continuation-in-part application of International application PCT/JP01/00611 filed Jan. 30, 2001, the entire contents of which are hereby incorporated by reference herein.

### BACKGROUND OF THE INVENTION

1. Technical Field

The present invention relates to a method for excluding or expelling a harmful or noxious insect by volatilization of a chemical that is high in repellent potency, has a long lasting potency and wherein the chemical is evaporated or volatilized at room temperature and yet at a reduced amount of energy.

2. Background Art

There has been known an electric mosquito-repellent utensil as a means to expel noxious or harmful insects such as mosquitoes. This apparatus has a mat or core impregnated with a chemical and is operated with a power supply available in a house and converted into thermal energy to heat the mat or core, thereby thermally volatilizing the chemical. This means, however, has the inconvenience that it cannot be used where a power supply is unavailable.

In order to resolve this problem, a study is en route to develop a portable mosquito-repellent apparatus powered with a battery to obtain sufficient heat energy to thermally volatilize a chemical. A battery used by such an apparatus is quickly consumed and it is now the situation that it is hard to make the apparatus practically usable.

Because all of allethrin, d,d-T80-prallethrin and the like, which are insecticidal technical products used for mosquito-repellent apparatus, have low volatility, they need more energy to be volatilized.

Debugging methods proposed in an attempt to resolve this problem include, for example, a method in which a porous carrier such as a resin is impregnated with dichlorvos, which is an organophosphorus chemical, and hung in the air; and a method in which such a carrier is accommodated in a receptacle to allow the chemical under the wind force of a fan to volatilize and diffuse. However, the use of an organophosphorus chemical to expel harmful or unhygienic insects has met with resistance from consumers because of a present increase in safety awareness, and neither of these methods has been found satisfactory.

Accordingly, by using transfluthrin, a pyrethroid chemical, which is volatile at room temperature and less harmful to men and beasts, a debugging apparatus is being developed in which a porous carrier impregnated with this chemical is ventilated with an air flow from a fan to volatilize and diffuse the active ingredient. The apparatus has been found effective with respect to certain harmful or noxious insects such as mosquitoes, but its expelling efficacy so far is not very sufficient as yet. In order to make up for the insufficiency in expelling efficacy, there is no choice but to increase the size of the carrier to make it impregnable with a larger amount of the chemical.

It should also be mentioned that a debugging apparatus or utensil capable of volatilization at room temperature for frequent opportunities of being used outdoors or in a field is more portable or handy if the apparatus or utensil is smaller in size. However, with the chemical described above, the problem with the size of the apparatus or utensil remains unresolved.

Accordingly, it is an object of the present invention to provide a method of debugging by chemical volatilization that can utilize a debugging apparatus which is advantageously smaller in size, that allows an active ingredient to thermally volatilize, not only by electric heating, but at a lower temperature using a warmer packed with chemical material, and further that permits an active ingredient to volatilize spontaneously.

### SUMMARY OF THE INVENTION

The present invention provides a method for excluding or expelling a harmful or noxious insect by chemical volatilization, characterized by using a preparation containing a chemical which is a non-organophosphorus chemical and which has a higher vapor pressure than d,d-T80-prallethrin and has a higher debugging potency than transfluthrin.

According to the present invention, using a chemical preparation which is higher in vapor pressure than d,d-T80-prallethrin allows the active ingredient to thermally volatilize, not only by electric heating, but at a lower temperature, using a warmer packed with chemical material. Also, a battery may be used to rotate a fan to volatilize the active ingredient by a wind created by the fan. Further, the active ingredient can be volatilized spontaneously and thereby debugging can be carried out where a power supply is unavailable.

Moreover, a high debugging potency of a chemical for use in the present invention permits using the chemical effectively in a reduced amount, enables a carrier or carriers therefor to be reduced in volume, and can employ a debugging apparatus which is advantageously smaller in size, compact and portable or handy.

These and other features, objects and advantages of the present invention will become more readily apparent to those of ordinary skill in the art from the following detailed description of the preferred forms of embodiments thereof and as illustrated in the drawing Figure.

### BRIEF DESCRIPTION OF DRAWING

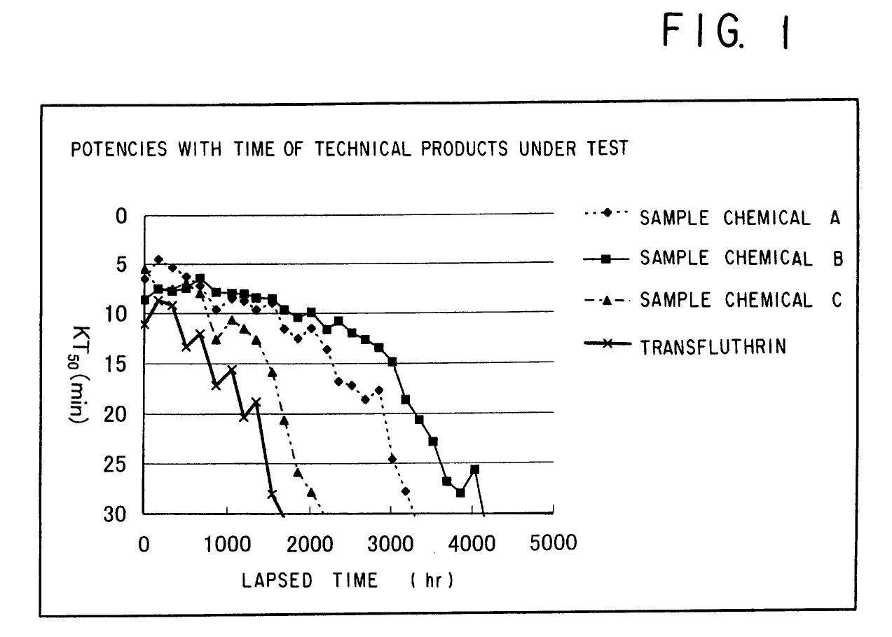

In the accompanying drawing, FIG. 1 is a graph that depicts potencies with time of various technical products under a test in an embodiment of the present invention.

### DETAILED DESCRIPTION OF THE INVENTION

An explanation is given hereinbelow in respect of an embodiment of the present invention.

In order to provide a satisfactory method for debugging noxious or harmful insects by volatilization of a chemical which resolves problems in the prior art as discussed hereinbefore, the investigations of the present inventors indicated that lines (types), vapor pressures and debugging potency or efficacy of chemicals must primarily be taken into account. In order for such a method to be practical, it is essential for the same to satisfy the requirements stated below.

(1) Lines (Types) of Chemicals

Such chemicals as diazinon and dichlorvos have long been well known as organophosphorus insecticides. These chemicals have been processed into a powder material or an oil solution or emulsion as an epidemic prevention or as agricultural chemicals. Among organophosphorus chemicals, dichlorvos, which is volatile at room temperature, has also been made available in the market in a form in which it exists as a volatile chemical and is impregnated in a resin for release into the atmosphere. While product chemicals using organophosphorus chemicals have been manufactured and sold on official approvals or permission, there is an unfillable gap in opinion between makers and consumer groups and in fact a movement has been brought about by some consumer groups to oppose the use of any organophosphorus chemical. Under the circumstances, the practice of a debugging method using a volatile chemical according to the invention involves refraining from using an organophosphorus chemical.

(2) Vapor Pressure

A chemical for use in this aspect of the present invention should have a vapor pressure more than that of d,d-T80-prallethrin.

This requirement not only enables a chemical if heated to volatilize at a lower temperature, but also enables a chemical to spontaneously volatilize or to be volatilized by the force of a wind created by a fan. Thus, this requirement permits a chemical to volatilize with a minimum amount of energy.

(3) Potency to Exterminate Noxious or Harmful Insects

A chemical for use in this aspect of the present invention should have a potency to debug that is higher than that of transfluthrin. This requirement enables a chemical to be minimized in volume.

At this point it should be noted that the terms “debug” and “exterminate” are used herein not only to mean “kill” in the narrow sense, but to mean “knock-down”, and “expel” or “drive out” from a space in which human beings exist. If the insect is a mosquito, such terms are also used to mean stop it from bloodsucking. Thus, the term “potency” or “efficacy” “to debug harmful or noxious insects” is intended to mean maintaining an environment in which a human being is unharmed or uninjured by insects. It should also be noted that the term “harmful or noxious insects” are used herein not only to mean unhygienic bugs such as flies and mosquitoes, but also to mean bugs such as chironomid which cause discomfort to human beings.

In order to confirm the correctness of the foregoing points of view according to the present invention and to affirm the presence of a chemical (technical product), three types of experimentation stated below were conducted.

Narrowing down chemicals (technical products) by preliminary tests (screening tests);

Survey on vapor pressures of chemicals (technical products) by vapor pressure comparative tests; and

Checking potency (efficacy) by chemical efficaciousness tests

1. Preliminary Tests (Screening Tests)

In order to understand if the following pyrethroid technical products (sample chemicals) A, B, C, D, E, F, G and H are usable chemicals for a chemical volatilizing debugging method according to the present invention, they were subjected, together with existing pyrethroid chemicals, to comparative debugging efficaciousness tests and comparative vapor pressure tests.

Sample Chemical A:

2,3,5,6-tetrafluoro-4-methoxymethylbenzyl 3-(1-propenyl)-2,2-dimethylcyclopropanecarboxylate

Sample Chemical B:

1-ethnyl-2-fluoro-2-pentenyl 3-(2,2-dichlorovinyl)-2,2-dimethylcyclopropanecarboxylate

Sample Chemical C:

2,3,5,6-tetrafluoro-4-methylbenzyl 3-(2-chloro-2-fluorovinyl)-2,2-dimethylcyclopropanecarboxylate

Sample Chemical D:

2,3,5,6-tetrafluoro-4-methoxybenzyl 3-(2,2-dichlorovinyl)-2,2-dimethylcyclopropanecarboxylate

Sample Chemical E:

2,3,5,6-tetrafluoro-4-methoxymethylbenzyl 3-(2-methyl-1-propenyl)-2,2-dimethylcyclopropanecarboxylate

Sample Chemical F:

2,3,5,6-tetrafluoro-4-methylbenzyl 3-(2-methyl-1-propenyl)-2,2-dimethylcyclopropanecarboxylate

Sample Chemical G:

2,3,5,6-tetrafluoro-4-methylbenzyl 3-(1-propenyl)-2,2-dimethylcyclopropanecarboxylate

Sample Chemical H:

1-ethynyl-2-methyl-2-pentenyl 3-(2-chloro-2-fluorovinyl)-2,2-dimethylcyclopropanecarboxylate

First, debugging efficaciousness tests were performed. For the criterion of judgment to compare degrees of efficaciousness, the effect of bloodsucking by mosquitoes of rats was adopted. Based on this, the following efficaciousness tests were carried out.

Comparative Debugging Efficaciousness Tests

Sample chemicals that were used were as follows: d,d-T80-prallethrin, transfluthrin, d1,d-T80-allethrin, d-T80-furamethrin, terallethrin and empenthrin; and pyrethroid technical products (sample chemicals) A, B, C, D, E, F, G and H.

Sample insects that were used were as follows: female adult stegomyia mosquitoes (Aedes albopictus) of Fumakilla (spelled phonetically) series 6^{th} to 9^{th} after emergence.

Sample chemical volatilizing form: A liquid type electric mosquito repellent utensil, a liquid agent (referred to below as “sample liquid”), obtained by diluting each of the sample chemicals with a solvent in a varying concentration, was allowed to volatilize.

Method used for tests: A test was conducted in two 8 straw mat (13.2 m²) rooms, one as a treatment zone and the other as a non-treatment zone, both in a no-wind state and at a constant room temperature of 32° C.

In the treatment zone, three cages each with a rat confined therein were placed equidistantly spaced apart (about 20 cm) in the center of the test room. The mosquito repellent utensil placed on the floor surface of the center of the test room was preliminarily electrically energized for operation, and to thermally volatilize each of the sample liquids and fumigate the room therewith for a period of 30 minutes, and then about 100 (one hundred) of sample mosquitoes were released into the test room. After two hours following the release of the mosquitoes, all these sample mosquitoes were knocked-down by using a mosquito repellent mat, and the number of the mosquitoes which had bloodsucking was counted to find the proportion of bloodsucking.

In the non-treatment zone, also, after the 2 hours of bloodsucking, the proportion of bloodsucking was found.

A rate of bloodsucking prevention was derived from the proportions of bloodsucking in the treatment and non-treatment rooms as expressed by the following equation:

Rate of bloodsucking prevention =[(Total bloodsucking proportion in the non-treatment zone−Total bloodsucking proportion in the treatment zone)÷Total bloodsucking proportion in the non-treatment zone]×100

Also, on the basis of these amounts of volatilization and rates of bloodsucking prevention, an amount of volatilization at a 50% rate of bloodsucking prevention (IC₅₀ value) and an amount of volatilization at a 90% rate of bloodsucking prevention (IC₉₀ value) are found and shown in Table 1 below.

TABLE 1
Bloodsucking Preventive Amounts of Volatilization and Potency
Ratios of Chemicals (including technical products)

| | | Potency | | Potency |
|---|---|---|---|---|
| Chemical | IC₅₀ Value | Ratio | IC₉₀ Value | Ratio |
| (primary body) | (mg/hr) | (Etoc 100) | (mg/hr) | (Etoc 100) |
| d,d-T80-prallethrin | 0.0081 | 100.0 | 0.039 | 100.0 |
| (Etoc) | | | | |
| Transfluthrin | 0.0430 | 19.0 | 0.134 | 29.2 |
| d1,d-T80-allethrin | 0.0630 | 12.9 | 0.412 | 9.5 |
| d-T80-furamethrin | 0.1170 | 6.9 | 0.270 | 14.4 |
| Terallethrin | 0.3650 | 2.2 | 1.028 | 3.8 |
| Empenthrin | 1.1390 | 0.7 | 3.354 | 1.2 |
| Sample Chemical A | 0.0041 | 197.1 | 0.0079 | 496.8 |
| Sample Chemical B | 0.0047 | 172.3 | 0.0083 | 469.9 |
| Sample Chemical C | 0.0062 | 130.6 | 0.0112 | 348.2 |
| Sample Chemical D | 0.0460 | 17.5 | 0.1830 | 21.3 |
| Sample Chemical E | 0.0590 | 13.7 | 0.1740 | 22.4 |
| Sample Chemical F | 0.1230 | 6.6 | 0.7240 | 5.4 |
| Sample Chemical G | 0.2890 | 2.8 | 0.8970 | 4.3 |
| Sample Chemical H | 0.4020 | 2.0 | 1.2780 | 3.1 |

While in Table 1 relative potency ratios with the potency of d,d-T80-prallethrin (Etoc) assumed to be 100 are shown, noting that chemicals which are more efficacious than transfluthrin are the above-identified Sample Chemicals A, B and C and d,d-T80-prallethrin (Etoc) and the latter must be excluded from the standpoint of vapor pressure, it proves that sample chemicals (technical products) A, B and C can be used for a debugging method according to the present invention.

On the other hand, allethrin, terallethrin, furamethrin and empenthrin are not used for the debugging method according to the present invention because of their lower effects of preventing mosquitoes from bloodsucking rats than transfluthrin.

2. Comparative Vapor Pressure Tests

Next, by using gas chromatography, the various chemicals including sample chemicals A, B and C screened out by the foregoing comparative debugging efficaciousness tests were compared with d,d-T80-prallethrin (Etoc) as regards to their vapor pressures.

The gas chromatography test included as its temperature conditions an initial temperature of 60° C., and a temperature rise of 5° C. per minute up to a maximum temperature of 250° C., which was held for a period of 5 minutes, whereupon the process ended.

The filler used was made up of methyl silicon polymer, which is non-polar.

It should also be noted that as an internal standard substance use was made of sebacic acid-n-butyl and which was added to confirm that there was no deviation in retention time from one test to another.

Retention times for the various chemicals are listed in Table 2 in the order of shorter to longer.

TABLE 2

| Chemical | Retention Time (min) |
|---|---|
| diethyl toluamide | 16.5 |
| Empenthrin | 20.1 |
| Terallethrin | 23.3 |
| transfluthrin | 23.6 |
| Sample Chemical C | 24.5 |
| Sample Chemical A | 25.1 |
| Sample Chemical B | 26.4 |
| d1,d-T80-allethrin | 26.6 |
| d,d-T80-prallethrin (Etoc) | 27.1 |
| Phenothorin | 33.7 |

Note that diethyl toluamide, not insect killer technical product, was used to take data for reference.

From the test results shown in Table 2, it is seen that sample chemicals A, B and C had a vapor pressure lower than transfluthrin, but higher than d,d-T80-prallethrin, and are thus chemicals which are suitable for use in the debugging method according to the present invention.

3. Comparative Debugging Efficaciousness Tests

Using sample chemicals A, B and C screened out by the preliminary tests, a test in which they were volatilized spontaneously (Example 1) and a test in which they were volatilized by being subjected to the wind power of a fan (Example 2) were carried out.

### EXAMPLE 1

### Qualification as Spontaneous Volatilization Chemicals

Using sample chemicals A, B and C screened out by the preliminary tests, the efficaciousness of each of them when allowed to volatilize spontaneously was compared with that of transfluthrin when allowed to volatilize spontaneously.

Sample Preparations (Chemicals and Their Carriers According to the Present Invention):

A non-woven polypropylene fabric (made by Idemitsu Petroleum Chemicals Co., Ltd., product name RW2100, density 100 grams/m²) of 50 cm×40 cm was coated with a hexane solution of 100 milliliter containing 1% (W/V) sample chemicals A, B, C and left to dry for 24 hours (effective amount of chemical: 1000 milligrams).

Comparative Preparation (Chemical and its Carrier):

A non-woven polypropylene fabric (made by Idemitsu Petroleum Chemicals Co., Ltd., product name RW2100, density 100 grams/m²) of 50 cm×40 cm was coated with a hexane solution of 100 milliliter containing 1% (W/V) of transfluthrin and left to dry for 24 hours (effective amount of chemical: 1000 milligrams).

Testing Method: Efficaciousness Tests in an 8 Straw Mat room with a volume of 33 m³

In the center of the test room with a volume of 33 m³ (3.65 m×3.65 m×2.5 m high), each chemical carrier as prepared as above was placed as hung on a hook suspended in the center of the room to let the corresponding chemical volatilize spontaneously for a period of 3 hours. Thereafter, a triangular net casing (20 cm×20 cm×16.4 cm high) of 16 mesh nylon net containing 10 (ten) female adult common house mosquitoes (Culex pipiens pallens) was placed as hung in an area at each of the four corners (spaced from the wall surfaces at a distance of 90 cm) at a height of 150 cm from the room floor and was exposed to the chemical atmosphere. The number of knockdowns with elapse of time from the exposure was observed in the room to calculate a KT₅₀ value according to the Bliss' probit method.

A test was also conducted likewise for the comparative carrier.

After the tests ended, the samples chemicals were let to volatilize spontaneously in the room having a constant temperature of 30° C. The same test was repeated at given intervals and efficaciousness was then examined each time.

Results of the tests are shown in Tables 3 and 4 below and also in FIG. 1.

TABLE 3
Relation between Elapsed Time and Potency in ease of Spontaneous Volatilization

| | KT₅₀ (min) changing with elapsed time (hr) | | | | | | | | | | | | |
|---|---|---|---|---|---|---|---|---|---|---|---|---|---|
| | 0 | 168 | 336 | 504 | 672 | 864 | 1056 | 1200 | 1344 | 1536 | 1680 | 1848 | 2016 |
| Sample chemical A | 6.53 | 4.52 | 5.38 | 6.28 | 7.25 | 9.60 | 8.50 | 8.80 | 9.70 | 8.97 | 11.60 | 12.50 | 11.50 |
| Sample chemical B | 8.64 | 7.53 | 7.77 | 7.48 | 6.45 | 7.90 | 8.00 | 8.00 | 8.40 | 8.60 | 9.60 | 10.40 | 9.87 |
| Sample chemical C | 5.53 | 7.53 | 7.55 | 6.95 | 7.98 | 12.60 | 10.70 | 11.50 | 12.60 | 15.90 | 20.70 | 25.90 | 27.80 |
| Transfluthrin | 11.10 | 8.73 | 9.17 | 13.40 | 12.10 | 17.20 | 15.60 | 20.40 | 18.80 | 28.10 | 30.40 | — | — |

TABLE 4
Relation between Elapsed Time and Potency in case of Spontaneous Volatilization

| | KT₅₀ (min) changing with elapsed time (hr) | | | | | | | | | | | | |
|---|---|---|---|---|---|---|---|---|---|---|---|---|---|
| | 2208 | 2352 | 2520 | 2688 | 2856 | 3024 | 3192 | 3360 | 3528 | 3696 | 3864 | 4032 | 4200 |
| Sample chemical A | 13.60 | 16.80 | 17.20 | 18.60 | 17.70 | 24.60 | 27.80 | 31.60 | — | — | — | — | — |
| Sample chemical B | 11.70 | 10.80 | 12.00 | 12.70 | 13.50 | 14.90 | 18.60 | 20.70 | 22.90 | 26.80 | 28.00 | 25.60 | 32.70 |
| Sample chemical C | 30.60 | — | — | — | — | — | — | — | — | — | — | — | — |
| Transfluthrin | — | — | — | — | — | — | — | — | — | — | | | |

From the results of Example 1, it is seen that sample chemicals A, B and C as used to volatilize spontaneously are each higher in potency and also longer in retention time than transfluthrin.

### EXAMPLE 2

### Qualification as Fan Wind Power Volatilization Chemicals

Using sample chemicals A, B and C screened out by the preliminary tests, the efficaciousness of each of them when caused to volatilize by the wind force of a fan was compared with that of transfluthrin when caused to volatilize by the wind force.

Comparative Preparation (Chemical and its Carrier):

A piece of paper was prepared impregnated with a solution of transfluthrin of 300 milligrams and was ventilated with a wind from a fan rotated by a motor at 1700 rpm to allow the active ingredient to volatilize and diffuse into the environment.

Sample preparation 1: A chemical A solution of 300 milligrams was used in place of the transfluthrin solution in the comparative preparation.

Sample preparation 2: A chemical B solution of 300 milligrams was used in place of the transfluthrin solution in the comparative preparation.

Sample preparation 3: A chemical C solution of 300 milligrams was used in place of the transfluthrin solution in the comparative preparation.

Living tests were conducted in an 8 (eight) straw mat (13.2 m²) room in which each of the preparations above was made active for 12 hours a day. It was found that the comparative preparation was effective (no mosquito bite) for about 40 days and Sample preparations 1, 2 and 3 in contrast were effective for about 90, 120 and 70 days, respectively.

As the test results of Example 2 show, the preparations made of sample chemicals A, B and C retain their efficacy significantly longer than the existing type of preparations. It is thus seen that, for example, to retain their efficacy for a same period, Sample preparations 1, 2 and 3 may have significantly less contents of their respective sample chemicals A, B and C or active ingredients, and may be smaller in size, than the comparative preparation.

It should be noted that a chemical preparation for use in the present invention may contain a repellent such as diethyl toluamide, an anti-oxidizing agent such as BHT, an insect growth control agent such as hydroprene, a synergist such as piperonyl butoxide, and/or any other insecticide, mite killer or microbicide not mentioned earlier (but excluding organophosphorus chemicals).

For certification of the present invention, each example is performed by using the same object to be exterminated and under the same experimental condition as those of the experiment by using transfluthrin which is the standard reference for comparison.

Among others, a method according to the present invention provides advantages as stated below.

Using a chemical preparation which is higher in vapor pressure than d,d-T80-prallethrin allows an active ingredient to thermally volatilize not only by electric heating, but at a lower temperature using a warmer packed with chemical material. Also, a battery may be used to rotate a fan and to allow an active ingredient to volatilize with a wind created by the fan. Further, an active ingredient can be volatilized spontaneously and thereby debugging can be carried out where a power supply is unavailable.

The high debugging potency of a chemical for use in the present invention permits using the chemical effectively in a reduced amount, enables its carrier or carriers to be reduced in volume, and can utilize a debugging apparatus advantageously smaller in size, compact and portable or handy.

Although the present invention has been described hereinbefore in terms of the presently preferred forms of embodiments with respect to or embodied in a method of volatilizing a chemical, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as compassing all alterations, modifications, or alternative applications as fall within the true spirit and scope of the invention.

What is claimed is:

1. A debugging method for expelling a harmful or noxious insect by chemical volatilization, comprising using a preparation containing a chemical which is a non-organophosphorus chemical and which has a higher vapor pressure than d,d-T80-prallethrin and has a higher debugging potency than transfluthrin.

2. The method of claim 1, wherein the higher debugging potency than transfluthrin is a higher effect for preventing mosquitoes from bloodsucking rats than transfluthrin when the chemical is volatilized in a room of a predetermined size.

3. A method for expelling a harmful or noxious insect comprising volatilizing a chemical which is a non-organophosphorous chemical and which has a higher vapor pressure than d,d-T80-prallethrin and has a higher debugging potency than transfluthrin, and contacting the chemical with the harmful or noxious insect or with a locus thereof.

4. The method of claim 3, wherein the chemical is 2,3,5,6-tetrafluoro-4-methoxymethylbenzyl 3-(1-propenyl)-2,2-dimethylcyclopropanecarboxylate.

5. The method of claim 3, wherein the chemical is ethnyl-2-fluoro-2-pentenyl 3-(2,2-dichlorovinyl)-2,2-dimethylcyclopropanecarboxylate.

6. The method of claim 3, wherein the chemical is 2,3,5,6-tetrafluoro-4-methylbenzyl 3-(2-chloro-2-fluorovinyl)-2,2-dimethylcyclopropanecarboxylate.
